(19) United States
(12) Patent Application Publication
(10) Pub. No.: US 2009/0065323 A1
(43) Pub. Date: Mar. 12, 2009

(54) Hydraulic actuating system for a motor vehicle clutch

(75) Inventor: Thomas Busold, Fulda (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/217,149

(22) Filed: Jul. 2, 2008

(30) Foreign Application Priority Data
Jul. 7, 2007 (DE) 10 2007 031 751.6

(51) Int. Cl. F16D 25/08

(52) U.S. Cl. 192/85 CA

(57) ABSTRACT

A hydraulic actuating system for a shiftable clutch installed in a drive train of a motor vehicle between an internal combustion engine and a transmission, which comprises at least one pressure source to produce a fluid pressure; a slave cylinder operably connected to the pressure source by which a clutch-release element of the vehicle clutch becomes subjectable to an actuating force; and a hydraulic clutch control means. The pressure source is configurable to create a compact and low-cost actuating system such that the maximum fluid pressure which it can produce is lower than that necessary at the slave cylinder to actuate the motor vehicle clutch. In this way, a hydraulic pressure booster becomes provided which can increase the fluid pressure to the level required for the clutch actuation.

### BACKGROUND OF THE INVENTION

1. Field of the Invention

The invention pertains to a hydraulic actuating system for a motor vehicle clutch and, more particularly, to a hydraulic actuating system for a motor vehicle clutch that is installed between a drive unit and a transmission.

2. Description of the Related Art

In hybrid powered motor vehicles that include an automatic transmission and a torque converter, which serves to set the vehicle in motion, these two components are controlled by a fluid pump, which is driven by an internal combustion engine. As long as the internal combustion engine is operating, this fluid pump runs continuously and, thus, continues to increase the pressure of the fluid. Typically, such a fluid pump is designed to provide a pressure of up to about 15 bars at a delivery of up to 120 L/min. When the internal combustion engine is turned off, e.g., when the motor vehicle is stopped at a traffic signal, the fluid pressure supply falls or becomes reduced, and the pressure lines in the automatic transmission leading to the clutches or brakes become partially emptied of fluid. In contrast, when the internal combustion engine is restarted, a start-up phase is therefore necessary to allow the fluid pressure to rebuild to the operating pressure.

To eliminate the lag time thus caused by this cycle, it is possible to install an electric motor-driven pump, which works independently of the internal combustion engine-driven pump. This electric pump is assigned the task of compensating for the pressure loss that occurs when the engine is stopped and is, thus, assigned the task of maintaining the operating pressure at all times. An operating pressure of approximately 4 bars at a delivery of at least about 3 L/min is normal for this type of electric pump.

The motor vehicle described above can be developed into a hybrid vehicle with an additional electric machine acting on the input shaft of the automatic transmission and with a shiftable clutch located between the internal combustion engine and the electric machine. When the internal combustion engine is being started by the electric machine, this shiftable clutch serves as a starting clutch and also serves to connect the combustion engine to, and from the vehicle's drive train. As a result, it becomes possible to drive the vehicle forward in the desired manner, either by the combustion engine alone or by the engine in combination with the electric machine. In order for the clutch to transmit a high drive and/or starting torque, a correspondingly high clutch or actuating force is required. This requirement is particularly true when the electric machine must start the combustion engine by accelerating the flywheel from a standstill. In order to permit the exertion of such high forces, a sufficiently high fluid pressure on the order of about 30-40 bars must be made available in the actuating system, and for the sake of dynamic clutching actions in particular, the fluid pressure must be made available immediately.

When the motor vehicle is stopped, the combustion engine can be turned off and disconnected from the drive train by the previously mentioned clutch. In principle, it is possible to allow the electric machine powered by the on-board electrical system to drive the fluid pump at the minimum necessary speed to maintain the operating pressure of the transmission fluid. The electric machine designed to drive the vehicle is supplied by an energy storage unit, however, and has a considerable power demand, which would lead to an undesirable and premature exhaustion of the energy storage unit.

It can be readily appreciated that the above-described hydraulic system for controlling the automatic transmission is not designed or suitable for the purpose of supplying the fluid pressure necessary to actuate the clutch. Consequently, a separate electric motor-driven fluid pump could be used as a fluid pressure source to supply the hydraulic actuating system of the clutch, where the pump provides a high fluid pressure at a relatively low delivery rate. A fluid pump of this type, however, is relatively large in size and requires an amount of space that is not usually available in the motor vehicle. In addition, the use of such a pump would also increase the system costs to an undesirable degree.

### SUMMARY OF THE INVENTION

In view of the foregoing, it is therefore an object of the present invention to provide a simple way to simply achieve a low-cost, hydraulic actuating system for a motor vehicle clutch installed between a drive unit and a transmission.

These and other objects and advantages are achieved in accordance with the invention by a hydraulic actuating system for a shiftable clutch installed in a drive train of a motor vehicle between an internal combustion engine and a transmission is provided. Here, the hydraulic actually system comprises at least one first pressure source to produce a fluid pressure, a slave cylinder operatively couple to the pressure source, by which a clutch-release element of the motor vehicle clutch can be subjected to an actuating force, and a hydraulic clutch control means.

In accordance with the invention, the pressure source is configurable to create a compact and low-cost actuating system such that the maximum fluid pressure which it can produce is lower than that necessary at the slave cylinder to actuate the motor vehicle clutch and such that a hydraulic pressure booster becomes provided to increase the fluid pressure to the level required for the clutch actuation. As a result, a fluid pressure is advantageously obtained, which is individually adjusted to a different value for each component, and which can be provided by a single pressure source for various hydraulically operated components of a motor vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in greater detail below by way of example on the basis of the attached figures in which:

FIG. 1 shows a schematic block diagram of a motor vehicle with a hydraulic actuating device; and

FIG. 2 shows a hydraulic actuating device configured in accordance with the present invention.

### DETAILED DESCRIPTION OF THE PRESENTLY PREFERRED EMBODIMENTS

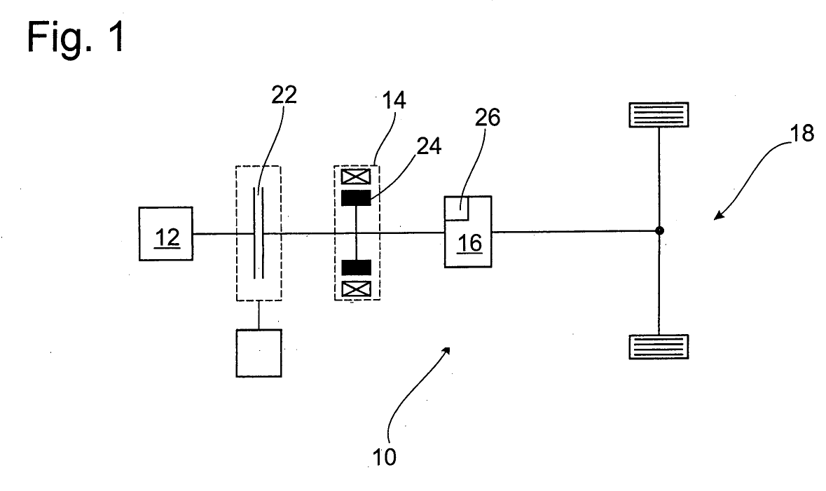

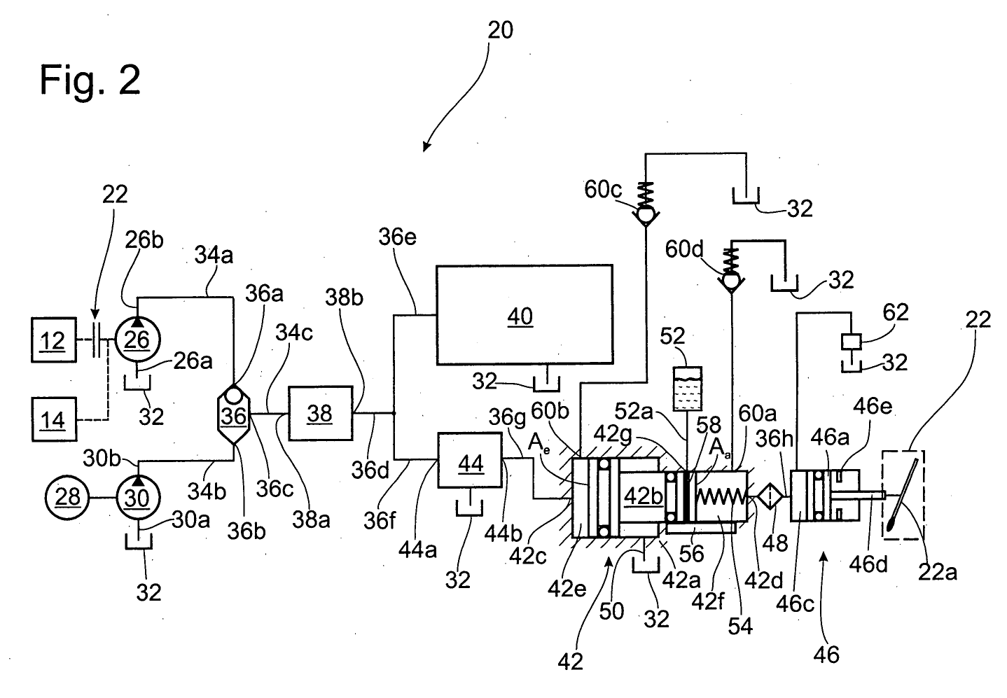

FIG. 1 shows a schematic block diagram of a hybrid vehicle 10 with an internal combustion engine 12 and an electric machine 14, which are each able to act on a drive axle 18 of the vehicle 10 through a gear change box 16 that is a fully automatic transmission. The takeoff shaft of the combustion engine 12 is connected to the rotor 24 of the electric machine 14 and to the input shaft of the transmission 16 by a clutch 22, which can be actuated by a hydraulic actuating system 20, as shown in FIG. 2. The specific design of the clutch 22 is irrelevant to the object of the present invention. That is, the clutch 22 can be designed as a “normally open” or as a “normally closed” clutch of the pulled or pushed type and can be either a dry-running or wet-running clutch. Thus, when the clutch 22 is closed, the electrical machine 14 can start the inactive combustion engine 12 from the stopped state, once the engine has been started, the vehicle 10 can be propelled by the combustion engine 12 alone or by the engine in combination with the electrical machine 14. A fluid pump 26, which can be driven by the engine 12 and can build up a hydraulic pressure when the clutch 22 is closed and the engine 12 is turning, is assigned to the automatic transmission 16 to control it in the conventional manner. In principle, when the clutch 22 is open or the engine 12 is stopped, the fluid pump 26 can also be driven in principle by the electrical machine 14. Here, however, the maximum fluid pressure which the fluid pump can generate is not sufficient to actuate the vehicle clutch.

FIG. 2 shows a detailed block diagram of the hydraulic actuating system 20 of FIG. 1, where the fluid pump 26, which is normally driven by the engine acting via the clutch 22, is provided as a first pressure source for actuating the clutch 22. The actuating system 20 is also provided with a fluid pump 30, which serves as a second pressure source. This pump is driven by an electric motor 28 and can be actuated independently of the first pressure source 26, thus ensuring that the clutch 22 can be actuated even if the engine 12 is disengaged and/or turned off, e.g., during times when the vehicle is only being operated by electric power. Nevertheless, the fluid pressures which either of the two pumps 26, 30 alone can generate is below the level required to actuate the clutch 22. As a result, without the following design, it is not possible for either of the pumps 26, 30 to initially actuate the clutch 22.

The two fluid pumps 26, 30 are connected by their fluid inlets 26a, 30a to a common fluid reservoir 32 and by their fluid outlets 26b, 30b and hydraulic lines 34a, 34b to the two inlets 36a, 36b of a passive switching valve 36. The fluid outlet 36c of the switching valve 36 is therefore connected automatically to the pump 26, 30 providing the higher fluid pressure at any given time. The switching valve 36 is in fluid connection with the fluid inlet 38a of a main pressure valve 38 in the form of, for example, an adjustable pressure-control valve, by means of the line section 34c. This main valve regulates the system pressure within the actuating system 20. The outlet 38b of the main pressure valve 38 is flow-connected by fluid lines 36d, 36e to a hydraulic transmission control means 40, more precisely, to a control unit 40 for controlling the automatic transmission 16. Thus, both fluid pumps 26, 30 are available to control the automatic transmission 16.

Another flow connection 36d, 36f exists between the main pressure valve 38 and a fluid pressure booster 42, which is provided to generate the operating pressure in the actuating system 20 of approximately 35-40 bars as required for clutch actuation. In an embodiment, the pressure booster 42 is integrated directly into the control unit 40. In an alternative embodiment, the pressure booster is a separate unit and is connected to the hydraulic control unit 20 by another hydraulic line. A hydraulic clutch control means 44 in the form of a pressure control valve 44, preferably a solenoid-operated proportional control valve, has a fluid inlet 44a and a fluid outlet 44b and can also be integrated into the control unit 40. The pressure control valve 44 serves to directly actuate the pressure booster 42. This pressure control valve is located in the flow route extending between the pressure booster 42 and the main pressure valve 38. The hydraulic control unit 40 is therefore able to control both the transmission and the clutch.

With additional reference to FIG. 2 both the fluid pressure generated by the first pressure source 26 and the fluid pressure generated by the second pressure source 30 are applied to the pressure booster 42 by a hydraulic line 36g, proceeding from the fluid outlet 44b of the pressure control valve 44. This pressure can be multiplied by the pressure booster 42. In accordance with the contemplated embodiments, the pressure booster 42 is a piston-cylinder unit with a cylinder housing 42a of graduated inside diameter and with a working piston 42b of correspondingly graduated outside diameter, which slides back and forth in the cylinder. The piston-cylinder unit has a fluid inlet 42c, a fluid outlet 42d, an inlet-side piston space 42e, and an outlet-side piston space 42f, which is sealed off from the inlet-side space. The fluid-actuatable piston area Aₑ on the inlet side is larger than the effective piston area Aₐ on the outlet side. The fluid outlet pressure acting at the fluid outlet 42d is therefore increased beyond the fluid inlet pressure by the ratio between the inlet-side piston area Aₑ and the outlet-side piston area Aₐ and thus boosted to the level required to actuate the clutch.

The pressure booster 42 also has a tank connection 50 located on the housing 42a between the piston areas Aₐ and Aₑ to conduct leakage oil to the fluid supply container 32 and to ensure that no negative pressure arises during the return stroke of the piston 42b. Another fluid connection 42g, which is connected to a fluid supply container 52 by a fluid line 52a and which is in the area of the outlet-side piston area Aₐ when the piston 42b is in its inward position reached by traveling from left to right (See FIG. 2), is also provided. This connection belongs to a fluid compensating device that is designed to prevent the occurrence of negative pressure during the return of the piston from an actuating position and to ensure that the loss of hydraulic fluid which occurs as the clutch 22 suffers wear over the course of time, can be compensated. For this purpose, for example, the piston 42b can be provided in the known manner with a shifting groove. Furthermore, a piston return device in the form of a compression spring 54 is installed inside the outlet-side piston space 42f between the piston area Aₐ and the bottom of the cylinder to support the return movement of the piston 42b back to its starting position.

The fluid outlet 42d of the pressure booster 42 is connected to the piston space 46c of a hydraulic cylinder 46 functioning as a slave cylinder of known design by another fluid line 36h. The piston 46a of this slave cylinder is in working connection with a clutch-release element 22a of the clutch 22 by a plunger 46d and can, thus, actuate the clutch-release element of the clutch. The piston spaces 42f and 46c and the fluid line 36h connecting them thus form a common pressure space. An in-line filter 48 is provided in the fluid line 36h to reliably prevent the passage of dirt into the slave cylinder 46 and, thus, prevent damage to the cylinder seals.

Furthermore, a position sensor 56, e.g., a PLCD sensor, is provided on the pressure booster 42 so that the actuation state of the clutch 22 can be detected. This sensor 56 detects the position of the piston 42b based on a permanent magnet 58, which travels along with the piston inside the cylinder housing 42a. Naturally, it will be appreciated that a position sensor 56 and the permanent magnet which might be required for it can also be mounted on the slave cylinder 46, on the clutch-release element 22a of the clutch 22, or in some other suitable position.

It is advantageous to provide appropriate vent devices of known design, e.g., vent screws, check valves, or pressure-limiting valves, at one or more points of the system of hydraulic lines to ensure effective venting. A variant of this measure is described below by way of example.

A preferably automatic vent device is assigned to the inlet-side piston space 42e, and another such device is assigned to the outlet-side piston space 42f, for which purpose the pressure spaces in question are connected to the pressure-limiting valves 60c, 60d, e.g., spring-loaded check valves, via fluid outlets 60a, 60b. As a result, fluid which escapes when the pressure is too high can be returned to the fluid supply reservoir 32. The opening pressure of the pressure-limiting valves 60c, 60d, is selected so that it is reached by the actuating system 20 only after the clutch 22 has been reliably actuated, e.g., opened. On the other hand, the opening pressure is lower than the maximum pressure which can be supplied by the hydraulic control unit 40. When the outlet-side piston space 42f is vented, measures must also be taken to reliably ensure that the clutch 22 will not be subjected to too much pressure. For this purpose, the outlet-side piston space 42f is made larger than the piston space 46c of the slave cylinder 46. With additional reverence to FIG. 2, this piston space of the slave cylinder is limited by a stop 46e on the side of the piston 46a facing away from the piston space 46c. When the piston 46a reaches this stop 46e during an actuating stroke, the fluid pressure increases in the piston spaces 42f, 46c connected by the connecting line 36h until the pressure-limiting valve 60d opens, and the fluid volume corresponding to the difference between the volumes of the piston spaces 42f, 46c can escape into the pressure-free fluid supply reservoir 32. Alternatively to the automatic vent device described above, it is also possible to provide a vent screw 62 on the slave cylinder 46 for the manual venting of the pressure spaces 42f, 46c.

A pressure accumulator, closed off on the pump side by a check valve, if desired, can be assigned to the first pressure source, that is, to the fluid pump 26. As a result, when an emergency occurs, such as the breakdown of the second pressure source 30 or the breakdown of the on-board electrical system supplying the electrical machine 14 and the electric motor 28, it becomes possible to actuate the clutch 22 at least once, where the connection for rotation in common with the internal combustion engine 12 is released simultaneously.

As an alternative to the pressure booster described above, it is also possible to design the booster as a continuously operating pressure booster with an oscillating piston system as described in DE 40 26 005 A1 and to integrate it into the hydraulic actuating system.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Hydraulic actuating system for a shiftable clutch installed in a drive train of a motor vehicle between an internal combustion engine and a transmission, comprising:
at least one first pressure source for providing a fluid pressure;
a slave cylinder operably coupled to the at least one pressure source and configured to subject a clutch-release element of the motor vehicle clutch to an actuating force, wherein the fluid pressure provided by the first pressure source is lower than the fluid pressure at the slave cylinder which is required to actuate the motor vehicle clutch; and
a hydraulic clutch control unit configured to control actuation of the motor vehicle clutch; and
a pressure booster connected between the first pressure source and the slave cylinder and configured to increase the fluid pressure received from the at least one first pressure source.

2. The hydraulic actuating system according to claim 1, wherein the pressure booster is a piston-cylinder unit.

3. The hydraulic actuating system according to claim 1, wherein the first pressure source is a fluid pump which is drivable by the internal combustion engine.

4. The hydraulic actuating system according to claim 1, further comprising a second pressure source for actuating the clutch.

5. The hydraulic actuating system according to claim 4, wherein the second pressure source is an electric motor-driven fluid pump.

6. The hydraulic actuating system according to claim 4, wherein the pressure which is producable by the second pressure source is lower than the pressure required at the slave cylinder to actuate the motor vehicle clutch.

7. The hydraulic actuating system according of claim 4, wherein an outlet of the second pressure source is connected to an inlet of the pressure booster.

8. The hydraulic actuating system according to claim 7, further comprising a switching valve, wherein the outlets of the first and second pressure sources selectively communicate with the pressure booster by the switching valve.

9. The hydraulic actuating system according to claim 1, wherein the transmission is configured as an automatic transmission and comprises a hydraulic transmission control means, and wherein the hydraulic clutch control means is integrated into the hydraulic transmission control means.

10. The hydraulic actuating system according to claim 1, wherein the clutch control means comprises a solenoid valve.

11. The hydraulic actuating system according to claim 1, further comprising a main pressure valve for regulating the fluid pressure.

12. The hydraulic actuating system according to claim 1, further comprising an in-line filter disposed between the pressure booster and the slave cylinder.

13. The hydraulic actuating system according to claim 1, further comprising a position sensor for sensing the actuation state of the clutch, said position sensor being arranged on the pressure booster or the slave cylinder.

14. The hydraulic actuating system according to claim 1, further comprising at least one automatic vent device.
